(19) United States
(12) Patent Application Publication
(10) Pub. No.: US 2025/0344119 A1
(43) Pub. Date: Nov. 6, 2025

(54) METHOD AND DEVICE FOR SELECTING NETWORK OF TERMINAL IN WIRELESS COMMUNICATION SYSTEM

(71) Applicant: Samsung Electronics Co., Ltd., Suwon-si, Gyeonggi-do (KR)

(72) Inventor: Kyungjoo SUH, Suwon-si (KR)

(21) Appl. No.: 18/705,767

(22) PCT Filed: Oct. 27, 2022
(86) PCT No.: PCT/KR2022/016595

§ 371 Date: Apr. 29, 2024

(30) Foreign Application Priority Data
Oct. 29, 2021 (KR) 10-2021-0146901

(51) Int. Cl. H04W 36/08; H04W 36/00; H04W 60/04; H04W 76/20; H04W 84/04

(52) U.S. Cl. CPC H04W 36/08; H04W 36/0061; H04W 60/04; H04W 76/20; H04W 84/042

(57) ABSTRACT

The present disclosure relates to a method for selecting a network by a terminal. The method may comprise receiving information about a network slice from a base station, wherein the information about the network slice includes at least one of information about a group of the network slice, information about priority of the network slice, and information about priority of the group of the network slice-; and performing cell selection or cell reselection based on the received information about the network slice.

### TECHNICAL FIELD

The disclosure relates to an apparatus and method for controlling selection and reselection of an access network by using a non-access stratum (NAS) layer or an access stratum (AS) layer in a wireless communication system. More particularly, the disclosure relates to a method and apparatus for selecting a network, network slice, radio access network (RAN), or public land mobile network (PLMN) to be accessed by a user equipment (UE) in consideration of a mobility situation, idle situation, or inactive situation of the UE.

### BACKGROUND ART

To meet the demand for wireless data traffic which has been increasing since the commercialization of 4G communication systems, efforts have been made to develop advanced 5G communication systems or pre-5G communication systems. For this reason, the 5G communication systems or the pre-5G communication systems are often referred to as beyond 4G network communication systems or post LTE systems. A 5G communication system defined by the 3GPP is referred to as a new radio (NR) system. To achieve high data rates, implementation of 5G communication systems in the ultra-high frequency (mmWave) band (e.g., the 60 GHz band) is under consideration. In order to mitigate the path loss of radio waves in the ultra-high frequency band and increase the transmission distance of radio waves, beamforming, massive MIMO, full dimensional MIMO (FD-MIMO), array antenna, analog beamforming, and large-scale antenna techniques have been discussed for the 5G communication systems, and these techniques have been applied to NR systems. In addition, to improve the networks of the systems, techniques such as advanced small cell, improved small cell, cloud radio access network (cloud RAN), ultra-dense network, device to device communication (D2D), wireless backhaul, moving network, cooperative communication, coordinated multi-points (COMP), and interference cancellation have been developed in the 5G communication systems. Besides, advanced coding modulation (ACM) schemes such as hybrid FSK and QAM modulation (FQAM) and sliding window superposition coding (SWSC) as well as advanced access schemes such as filter bank multi carrier (FBMC), non-orthogonal multiple access (NOMA), and sparse code multiple access (SCMA) are being developed for the 5G systems.

### DETAILED DESCRIPTION OF THE INVENTION

### Technical Problem

The disclosure is intended to provide an apparatus and method for controlling selection and reselection of an access network by using a NAS layer and an AS layer in a wireless communication system.

### Technical Solution

According to an embodiment of the disclosure, a method for selecting a network by a terminal includes: receiving information about a network slice from a base station, wherein the information about the network slice includes at least one of information about a group of the network slice, information about priority of the network slice, and information about priority of the group of the network slice; and performing cell selection or cell reselection based on the received information about the network slice.

According to an embodiment of the disclosure, a method for supporting network selection of a terminal by an access and mobility management function (AMF) includes: generating information about a network slice, wherein the information about the network slice includes at least one of information about a group of the network slice, information about priority of the network slice, and information about priority of the group of the network slice; and transmitting the generated information about the network slice to the terminal.

According to an embodiment of the disclosure, a method for supporting network selection of a UE by a base station includes: receiving information about a network slice from a network entity performing an access and mobility management function, wherein the information about the network slice includes at least one of information about a group of the network slice, information about priority of the network slices, or information about priority of the group of the network slice; and transmitting the received information about the network slice to the terminal.

According to an embodiment of the disclosure, a terminal for selecting a network includes: a transceiver; and a processor coupled to the transceiver. The processor is configured to: receive information about a network slice from a base station, wherein the information about the network slice includes at least one of information about a group of the network slice, information about priority of the network slice, and information about priority of the group of the network slice; and perform cell selection or cell reselection based on the received information about the network slice.

According to an embodiment of the disclosure, an AMF device for supporting network selection of a terminal includes: a transceiver; and a processor coupled to the transceiver. The processor is configured to: generate information about a network slice, wherein the information about the network slice includes at least one of information about groups of the network slices, information about priority of the network slice, and information about priority of the group of the network slice; and transmit the generated information about the network slice to the terminal.

According to an embodiment of the disclosure, a base station for supporting network selection of a terminal includes: a transceiver; and a processor coupled to the transceiver. The processor is configured to: receive information about a network slice from a network entity performing an access and mobility management function, wherein the information about the network slice includes at least one of information about a group of the network slice, information about priority of the network slice, and information about priority of the group of the network slice; and transmitting the received information about the network slice to the terminal.

### Advantageous Effects

According to an embodiment of the disclosure, when various network slices and various services are requested in a wireless communication system, a UE may be supported to efficiently select a network, network slice, RAN, or PLMN to be accessed by the UE according to a state (inactive, active, or connected state) of the UE.

### BRIEF DESCRIPTION OF DRAWINGS

FIG. 1 illustrates a network environment according to an embodiment of the disclosure.

FIG. 2 is a flowchart illustrating a procedure of selecting a network to be accessed according to a service to be accessed and a state of a UE by the UE according to an embodiment of the disclosure.

FIG. 3 is a flowchart illustrating a procedure of selecting a network to be accessed according to a service to be accessed and a state of a UE by the UE according to an embodiment of the disclosure.

FIG. 4 is a flowchart illustrating a procedure of selecting a network to be accessed according to a service to be accessed and a state of a UE by the UE according to an embodiment of the disclosure.

FIG. 5 is a flowchart illustrating a procedure of selecting a network to be accessed according to a service to be accessed and a state of a UE by the UE according to an embodiment of the disclosure.

FIG. 6 is a flowchart illustrating a procedure of selecting a network to be accessed according to a service to be accessed and a state of a UE by the UE according to an embodiment of the disclosure.

FIG. 7 is a block diagram illustrating the configuration of a UE according to an embodiment of the disclosure.

FIG. 8 is a block diagram illustrating the configuration of a network entity according to an embodiment of the disclosure.

FIG. 9 is a flowchart illustrating a procedure of selecting a network to be accessed according to a service to be accessed and a state of a UE by the UE according to an embodiment of the disclosure.

### MODE FOR CARRYING OUT THE INVENTION

Embodiments of the disclosure will be described below in detail with reference to the accompanying drawings. In describing the embodiments, a description of technical content which is well known in the technical field of the disclosure and not directly related to the disclosure will be avoided, lest it should obscure the subject matter of the disclosure. This is done to make the subject matter of the disclosure clearer without obscuring it by omitting an unnecessary description.

For the same reason, some components are shown as exaggerated, omitted, or schematic in the accompanying drawings. In addition, the size of each component does not fully reflect the actual size. In each drawing, the same reference numerals are assigned to the same or corresponding components.

The advantages and features of the disclosure and a method of achieving them will become apparent from reference to embodiments described below in detail in conjunction with the attached drawings. However, the disclosure may be implemented in various manners, not limited to the embodiments set forth herein. Rather, these embodiments are provided such that the disclosure is complete and thorough and its scope is fully conveyed to those skilled in the art, and the disclosure is only defined by the appended claims. The same reference numerals denote the same components throughout the specification.

It will be understood that each block of the flowchart illustrations and combinations of the flowchart illustrations can be implemented by computer program instructions.

Furthermore, the respective block diagrams may illustrate some of modules, segments, or codes including one or more executable instructions for performing specific logic function(s). In addition, it is to be noted that the functions of the blocks may be performed in a different order in several alternative implementations. For example, two successive blocks may be performed substantially at the same time, or may be performed in reverse order according to corresponding functions in some cases.

The term ‘unit’ as used herein means, but is not limited to, a software or hardware component, such as a field programmable gate array (FPGA) or application specific integrated circuit (ASIC), which performs certain tasks. A ‘unit’ may be configured to reside on an addressable storage medium and configured to be executed on one or more processors. Thus, a ‘unit’ may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and ‘units’ may be combined into fewer components and ‘units’ or further separated into additional components and ‘units’. In addition, the components and ‘units’ may be implemented such that they are executed on one or more CPUs in a device or a secure multimedia card. Further, a unit' may include one or more processors in an embodiment.

Terms identifying access nodes, terms indicating network entities, terms indicating messages, terms indicating interfaces between network entities, terms indicating various pieces of identification information, and so on as used in the disclosure are illustratively provided, for convenience of description. Accordingly, the disclosure is not limited to the terms described below, and other terms having equivalent technical meanings may be used.

While the disclosure uses terms and names defined in the 3^{rd} generation partnership project long term evolution (3GPP LTE) standards, or modified terms and names based on the terms and names, the disclosure may be equally applied to systems conforming to other standards, not limited by the terms and names. In the disclosure, the terms eNB and gNB may be interchangeably used with each other, for convenience of description. That is, a base station (BS) described as an eNB may be indicated as a gNB. In the disclosure, the term user equipment (UE) may refer to various communication devices as well as a hand-held phone, an NB-IoT device, and a sensor.

That is, although the embodiments of the disclosure will be described in detail mainly in the context of the communication standards established by the 3GPP, the subject matter of the disclosure is also applicable to other communication systems having a similar technical background, with a slight modification without greatly departing from the scope of the disclosure, as judged by those skilled in the art.

In a 5G or NR system, a management entity managing the mobility of a UE, access and mobility management function (AMF) and an entity managing a session, session management function (SMF) are separated from each other. As a result, unlike in the 4G LTE communication system where a mobility management entity (MME) performs mobility management and session management together, the entity that perform mobility management and the entity that performs session management are separated in the 5G or NR system, which changes a communication method and a communication management method between a UE and a network entity.

In the 5G or NR system, for non-3GPP access, mobility management is performed through the AMF through a non-3gpp inter-working function (N3IWF), and session management is performed through the SMF. The AMF also processes security-related information, which is a critical element of mobility management.

As described above, the MME is responsible for both mobility management and session management in the 4G LTE system. The 5G or NR system may support a non-standalone architecture that performs communication using network entities of the 4G LTE system together.

The disclosure provides an apparatus and method for controlling selection or reselection of an access network using a NAS in a wireless communication system, and a method and apparatus for selecting a network, network slice, RAN, or PLMN to be accessed by a UE in a mobility situation, idle situation, or inactive situation of the UE. Therefore, the disclosure may support a UE to efficiently select a network to be accessed by the UE according to the inactive, idle, and connected states of the UE, when various network slices and various services are requested in a wireless communication system.

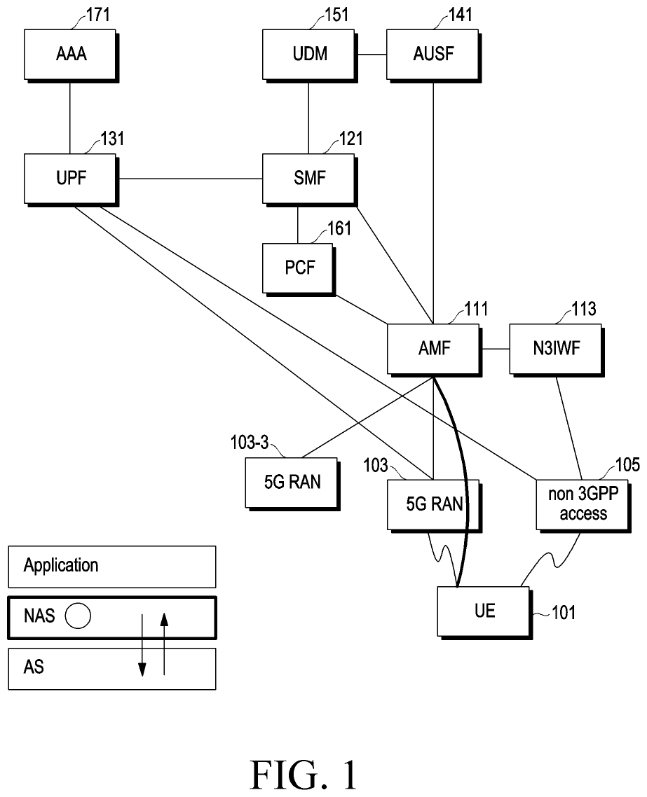

FIG. 1 illustrates a network environment according to an embodiment of the disclosure. In embodiments of the disclosure, a UE may select a network to be accessed based on a service to be accessed and the state of the UE in a corresponding network environment.

Referring to FIG. 1, a 5G core network or NR core network may include network functions (NFs) such as a user plane function (UPF) 131, an SMF 121, an AMF 111, a 5G radio access network (RAN) 103, a user data management (UDM) 151, and a policy control function (PCF) 161. In addition, the 5G core network or NR core network may include entities such as an authentication server function (AUSF) 141 and an authentication, authorization and accounting (AAA) 171, for authenticating these entities. A UE (or terminal) 101 may access the 5G core network through BSs (5G RANs 103 and 103-3). An N3 interworking function (N3IWF) supports communication of the UE 101 through non-3GPP access. In the non-3GPP access, session management is controlled by the UE, the non-3GPP access, the N3IWF, and the SMF, and mobility management is controlled by the UE, the non-3GPP access, the N3IWF, and the AMF.

In the 5G or NR system, entities that perform mobility management and session management are separated into the AMF 111 and the SMF 121. The 5G or NR system also considers a standalone deployment structure where communication is performed only using 5G or NR entities, and a non-standalone deployment structure where 4G entities and 5G or NR entities are used together.

As illustrated in FIG. 1, the deployment may be such that when the UE communicates with a network, an eNB (i.e., the BSs 103 and 103-3) performs control and the 5G entities of a core network are used. In this case, mobility management between the UE 101 and the AMF 111 and session management between the UE 101 and the SMF 121 may be performed at the NAS layer of layer 3. Meanwhile, the AS at layer 2 may be involved in transmission of data and control information between the UE 101 and the eNB.

While the disclosure assumes 5G and 4G LTE communication networks, the same concept may be applied to other systems within the scope that those skilled in the art may understand.

In the disclosure, the UE 101 may move between the 5G RAN 103 and the 5G RAN 103-3 in a UE radio resource control (RRC) connected state, an RRC inactive state, and an RRC idle state.

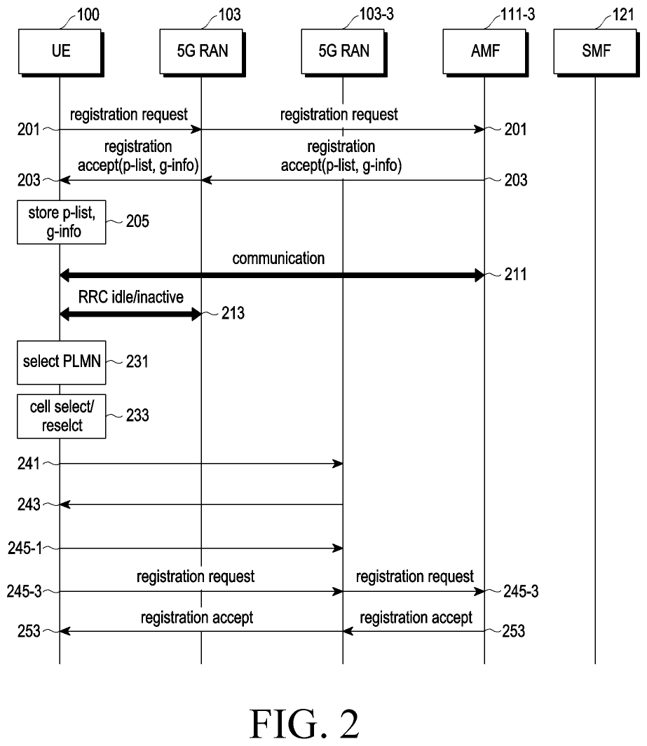

FIG. 2 is a flowchart illustrating a procedure in which a UE selects a network to be accessed according to a service to be accessed and the state of the UE according to an embodiment of the disclosure.

In step 201, the UE 101 transmits a registration request message, which is a NAS message, to the AMF 111 through the 5G RAN (i.e., BS) 103. The 5G RAN 103 forwards the NAS message transmitted between the UE 101 and the AMF 111 through bypassing.

In step 203, the AMF 111 transmits a registration accept message, which is a NAS message, to the UE 101 through the 5G RAN 103. The registration accept message may include information about network slices related to the UE 101. The information about the network slices may include at least one of information g-info about at least one group of network slices available to the UE 101, information about priorities of the network slices, or information p-list about priorities of the network slice groups. The information about the network slices will be described below in more detail.

A network slice may be identified by a single-network slice selection assistance information (S-NSSAI). Particularly, the network slice may be identified by a slice/service type (SST) and slice differentiator (SD) of the S-NSSAI.

The value of the SST may be set to indicate one of, for example, enhanced mobile broadband (eMBB), ultra reliable low latency communication (URLLC), media centric internet of things (MIoT), V2X, or massive machine-type communications (MHTC). The SST may be allocated, but not limited to, 8 bits.

The SD is used to distinguish multiple network slices having the same SST from each other. For example, a URLLC slice used for a surgical operation in a hospital and a URLLC slice used for a precision automatic machine may be distinguished from each other by SDs. Further, a slice used for a dedicated service in hospital A and a slice used for a dedicated service in hospital B may be distinguished from each other by SDs among URLLC slices used for surgical operations in hospitals. The SD may be allocated, but not limited to, 24 bits. In some embodiments, the SD may optionally be included in the S-NSSAI.

Network slices may be grouped by grouping S-NSSAIs using SSTs or both SSTs and SDs. Priorities may be assigned to the groups. Information about the groups and their priorities may be transmitted to the UE 101.

Table 1 below illustrates an example of assigning priorities to network slices and network slice groups.

TABLE 1

| | NS(Network | | NS | NS | NS group | Individual NS |
|---|---|---|---|---|---|---|
| S-NSSAI | slice) SST | NS SD | group 1 | group 2 | priority | priority |
| S-NSSAI-1 | 1(eMBB) | | G-1 | 1 | 4 | 4 |
| S-NSSAI-2 | 2(URLLC) | Surgical operation- | G-2 | 2 | 1 | 1-1 |
| | | hospital A | | | | |
| S-NSSAI-3 | 2(URLLC) | Surgical operation - | G-2 | 2 | 1 | 1-2 |
| | | hospital B | | | | |
| S-NSSAI-3 | 2(URLLC) | Precision automatic | G-3 | 3 | 2 | 2 |
| | | machine-C | | | | |
| S-NSSAI-5 | 3(mIoT) | | G-4 | 4 | 6 | 6 |
| S-NSSAI-6 | 4(V2X) | | G-5 | 5 | 3 | 3 |
| S-NSSAI-7 | 5(HMTC) | | G-6 | 6 | 5 | 5 |

As noted from the above table, a character sequence (i.e., a string) may be used to represent a group, as in ‘NS group 1’, or a number or bit sequence (i.e., a string) may be used, as in ‘NS group 2’. In some embodiments, a number used to represent a group may be a binary representation of an integer. For example, when 4 bits are allocated to represent a group, ‘0001’ may be used for 1 and ‘0010’ may be used for 2. When 8 bits are allocated to represent a group, ‘00000001’ may be used for 1 and ‘00000010’ may be used for 2.

Since an S-NSSAI includes SST information and SD information, it is possible to group network slices based on SST information or a combination of SST information and SD information. To allocate radio resources or resources of a core network or allocate radio resources in the frequency domain and the time domain, based on information about the groups, priorities may be assigned to the individual groups and the individual slices of each group. Information about the groups and information about their priorities may be transmitted to the UE 101 in the form of p-list, g-info, network slice groups, network slice group information, a network slice group list, a network slice priority list, or network slice priorities.

For example, when information indicating G-1, G-2, G-3, and G-5 as groups available to the UE 101 is transmitted to the UE 101, group priority information is 4, 1, 2, and 3, respectively, and individual NS priority information is 4, 1-1, 1-2, 2, and 3, respectively. In other words, information such as groups, priorities, and S-NSSAIs (including SSTs and SDs) corresponding to them may be transmitted.

As information about the priorities of the network slices, only information (i.e., an NS group priority) about the priority of a group may be transmitted according to an embodiment, only information (i.e., an NS individual priority) about the priority of each slice in the group may be transmitted according to another embodiment, and information about the priority of the group and information about the priority of each slice in the group may be transmitted according to another embodiment.

According to an embodiment, when the information about the network slices is transmitted through the NAS or the AS, related information may be sorted by group and transmitted to the UE 101, as illustrated in Table 2 below.

TABLE 2

| NS | NS group | Individual | | | |
|---|---|---|---|---|---|
| group | priority | NS priority | S-NSSAI | NS SST | NS SD |
| G-1 | 4 | 4 | S-NSSAI-1 | 1(eMBB) | |
| G-2 | 1 | 1-1 | S-NSSAI-2 | 2(URLLC) | Surgical operation-hospital A |
| G-2 | 1 | 1-2 | S-NSSAI-3 | 2(URLLC) | Surgical operation-hospital B |
| G-3 | 2 | 2 | S-NSSAI-3 | 2(URLLC) | Precision automatic machine-C |
| G-4 | 6 | 6 | S-NSSAI-5 | 3(mIoT) | |
| G-5 | 3 | 3 | S-NSSAI-6 | 4(V2X) | |
| G-6 | 5 | 5 | S-NSSAI-7 | 5(HMTC) | |

According to another embodiment, the information about the network slices may be sorted by priority and transmitted to the UE 101.

In some embodiments, after the UE 101 receives the information about the network slices transmitted by group, the NAS layer or AS layer of the UE 101 may sort the groups by priority to ensure that when allocating time, frequencies, radio network resources, or resources of the core network to a group with a higher priority, good resources are allocated with priority.

In step 205, the UE 101 stores the information about the network slices received from the network. The information about the network slices received at the NAS layer may be stored in a USIM or non-volatile memory.

In step 211, the UE 101 may perform communication with the network.

In step 213, the UE 101 and the 5G RAN 103 may be in the RRC idle state or the RRC inactive state.

In step 231, the UE 101 may select a public land mobile network (PLMN).

In step 233, the UE 101 may perform cell selection/cell reselection. This will be described below in more detail.

A PLMN may be identified by a mobile country code (MCC) and a mobile network code (MNC).

Information about PLMNs in a cell is included in system information, and broadcast.

In an embodiment, the network slice-related information may be broadcast. The provided information may include slice priority information and slice-related group information.

In another embodiment, the network slice-related information may be provided through a dedicated signal.

In an embodiment, the network slice-related information may be provided for at least one serving frequency.

In other embodiments, the network slice-related information may also be provided for one or more neighboring frequencies.

The slice priority information indicates the priority of each of at least one slice. The slice priority-related information is a list of the priority of each of the at least one slice. A higher bandwidth may be allocated for a slice with a higher priority based on the slice priority information. To allocate a higher bandwidth to a slice with a higher priority, a higher frequency may be allocated. Priorities may be assigned to slices in consideration of quality of service and time (because a service such as a URLLC service is time-critical), and radio resources with a larger bandwidth may be allocated for a slice group to which a higher priority is assigned in consideration of a bandwidth in relation to an eMBB slice.

Network slices may be grouped by type based on the slice group-related information, and radio resources may be allocated in the frequency domain and time domain for each group. For example, network slice selection assistance information (NSSAI) as information about the type of a network slice (e.g., indicating a service such as eMBB, URLLC, mMTC, V2X, or the like), description information about the network slice, and detailed information about the network slice. Accordingly, information about a group may be provided such that slices of the same type may be grouped together based on information about a network slice in an NSSAI, and thus a specific group may be serviced with good resources (in time and frequency). In some embodiments, the network may group slices with the same data network name (DNN) or slices serviceable through flow bundling into the same group, and provide corresponding information to the UE.

When the UE is initially powered on, the UE searches for available PLMNs and select an appropriate PLMN from which the UE may receive a service.

The NAS layer of the UE indicates to the AS layer that PLMN selection is required.

The AS layer searches a band and indicates a list of one or more detected PLMNs to the NAS layer.

The NAS layer of the UE may select a PLMN to which the UE is to be registered from the list of one or more PLMNs. In some embodiments, the UE may select a PLMN to which the UE is to be registered based on a priority order for PLMN/RAT selection stored in the USIM or the non-volatile memory.

Regarding cell selection/reselection, the NAS layer and the AS layer operate as follows.

The NAS layer provides slice information to the AS layer. The provided information may include slice priority information and slice group information. A group with a higher priority may be serviced with priority over other groups with lower priorities. In an embodiment, the AS layer may select a slice with a higher priority and assign a higher frequency to the slice with the higher priority. The AS layer may perform measurements in order from a highest frequency to a lowest frequency. When a high-ranked cell is a suitable cell and capable of providing a service to the selected slice, the cell may be camped on.

The UE detects suitable cells among cells to which the PLMN belongs and selects a cell capable of providing an appropriate service. A suitable cell, which is a cell in which the UE may receive a suitable service, should be not only an acceptable cell, but also a cell that belongs to a PLMN accessible to the UE, and is not prohibited from performing a registration procedure for the UE. Further, when the cell is a closed access group cell (CAG), the UE should be a member of the CAG and the cell should be accessible to the UE.

A cell from which the UE may receive limited services is referred to as an acceptable cell. An acceptable cell is a cell that does not bar the UE from camping on the cell and satisfies a cell selection criterion of the UE. That is, the acceptable cell satisfies a criterion for a signal strength, a signal quality, or the like. The limited services may include an emergency call or services related to earthquake and tsunami warning systems (ETWS), and these services may be provided by the acceptable cell.

Exemplary PLMN selection schemes will be described below.

### Case 1

In case 1, a PLMN and an access technology in the PLMN are selected according to general rules.

In an automatic PLMN selection scheme, the order of priorities for PLMN selection is given as follows.
1) Registered PLMN (RPLMN, i.e., a PLMN to which the UE was last registered) or equivalent PLMN (EPLMN, i.e., a PLMN that is treated as equivalent to the RPLMN)
2) User-controlled PLMN and access technology

A user-controlled PLMN list assigns priorities to PLMNs available for user registration. A radio access technology identifier identifies a radio network available for user registration. This information is stored in the USIM of the UE. For the information, PLMN updates and deletions may be performed by the subscriber.
3) Operator-controlled PLMN and access technology

An operator-controlled PLMN list provides the priorities of PLMNs available for UE registration in the absence of a user-controlled PLMN list. A radio access technology identifier may identify a radio network available for user registration. This information is stored in the USIM of the UE. For the information, PLMN updates and deletions may not be performed by a personal identification number (PIN) of the subscriber. Information about the operator-controlled PLMNs is configured in the USIM by an operator.
4) PLMN reported as high-quality PLMN by AS layer.

### Case 2

Case 2 differs from case 1, when a PLMN is selected through operator-controlled PLMNs or user-controlled PLMNs.
Case 2-1) Operator-controlled PLMNs are used. Herein, network slice priority information and network slice group information may be used together with an access technology.

In the automatic PLMN selection scheme, the order of priorities for PLMN selection is given as follows.
1) RPLMN or EPLMN
2) User-controlled PLMN and access technology
3) Operator-controlled PLMN and access technology

An operator-controlled PLMN list provides the priorities of PLMNs available for UE registration in the absence of a user-controlled PLMN list. A radio access technology identifier identifies a radio network available for user registration. This information is stored in the USIM of the UE. PLMN information and radio access identifiers are stored in the USIM, whereas information about network slices including information about groups of the network slices and information about the priorities of the network slices may be stored in the non-volatile memory. In some embodiments, the PLMN information, the radio access identifiers, and the information about the network slices information may be stored in the non-volatile memory. PLMN updates and deletions for the stored information may not be performed by the PIN of the subscriber.

The operator may provide the UE with information about operator-controlled PLMNs. The information about the operator-controlled PLMNs is configured in the USIM of the UE by the operator. The PLMN information and radio access identifiers may be stored in the USIM, whereas information about network slices including information about groups of the network slices and information about the priorities of the network slices may be stored in the non-volatile memory. In some embodiments, the PLMN information, the radio access identifiers, and the information about the network slices may be stored in the non-volatile memory.

In relation to the operator-controlled PLMNs, the information about the network slices including the information about the groups of the network slices and information about the priorities of the network slices, and so on may be transmitted from the BS, from the AMF through the BS, or from the AMF to the UE.
3-1) In an embodiment, the information about the network slices may be configured in the UE by being pre-configured in the operator-controlled PLMN list and stored in the USIM.
3-2) Alternatively, the AMF or the 5G RAN may transmit configure the information about the network slices including the information about the priorities of the network slices, the information about the groups of the network slices, and so on to the UE and configured them, and the UE may store the information about the network slices together with the operator-controlled PLMNs (i.e., information indicating the operator-controlled PLMNs). Accordingly, the UE may select an operator-controlled PLMN according to its priority during PLMN selection.
3-2-1) In an embodiment, the information about the network slices including the information about the priorities of the network slices and the information about the groups of the network slices, transmitted with these operator-controlled PLMNs, may be transmitted from the AMF to the UE in the registration accept message. The information about the network slices may also be transmitted from the 5G RAN to the UE through an RRC message or an SIB.

That is, the network information such as the information about the priorities of the network slices and the information about the groups of the network slices may be transmitted from the AMF to the UE in the registration accept message, when the UE successfully registers to a home PLMN (HPLMN). The network information may also be transmitted from the 5G RAN to the UE through an RRC message or an SIB.

The UE may store the received information about the network slices as information about the operator-controlled PLMNs. For example, the UE may store the received information about the network slices together with information about the operator-controlled PLMNs, or as information about the operator PLMNs.
3-2-2) In an embodiment, the registration accept message may include a new parameter. That is, the information about the priorities of the network slices and the information about the groups of the network slices together with information about PLMNs available for UE registration may be transmitted from the AMF to the UE by using an information element, and also from the 5G RAN to the UE through an RRC message including the new parameter. When the UE receives this information, the UE may store it in the information about the operator-controlled PLMNs.
4) PLMN reported as high-quality PLMN by AS layer.
Case 2-2) User-controlled PLMNs are used. Information about the priorities of network slices and information about the groups of the network slices may be used together with an access technology.

In the automatic PLMN selection scheme, the order of priorities for PLMN selection is given as follows.
1) RPLMN or EPLMN
2) User-controlled PLMN and access technology

A user-controlled PLMN list assigns priorities to PLMNs available for user registration. A radio access technology identifier identifies a radio network available for user registration. This information may be stored in the USIM of the UE. PLMN information and radio access identifiers may be stored in the USIM, whereas information about network slices including about groups of the network slices and information about the priorities of the network slices may be stored in the non-volatile memory. In some embodiments, the PLMN information, the radio access identifiers, and the information about the network slices may be stored in the non-volatile memory. PLMN updates and deletions for the stored information are performed by the subscriber.

In relation to the user-controlled PLMNs, the information about the network slices including the information about the priorities of the network slices and the information about the groups of the network slices may be transmitted from the BS, from the AFM through the BS, or from the AMF to the UE.
2-1) In an embodiment, the information about the network slices may be configured in the UE by being pre-configured in a user-controlled PLMN list and stored in the USIM.
2-1) In another embodiment, the information about the network slices is configured for the UE by the AMF and stored together with the user-controlled PLMNs.
2-2-1) The information about the network slices transmitted together with the user-controlled PLMNs may be transmitted from the AMF to the UE in the registration accept message, or from the 5G RAN to the UE through an RRC message or an SIB.

That is, the information about the network slices such as the information about the priorities of the network slices and the information about the groups of the network slices may be transmitted from the AMF to the UE in the registration accept message or from the 5G RAN to the UE in an RRC message or an SIB, when the UE successfully registers to the HPLMN.

The UE may store the received information about the network slices in information about the user-controlled PLMNs. For example, the UE may store the received information about the network slices together with information about the user-controlled PLMNs, or as information about the user-controlled PLMNs.
2-2-2) In an embodiment, the registration accept message may include a new parameter. That is, the information about the priorities of the network slices and the information about the groups of the network slices together with information indicating PLMNs available for UE registration may be transmitted from the AMF to the UE by an information element. In some embodiments, the information about the priorities of the network slices and the information about the groups of the network slices may be transmitted in an RRC message from the 5G RAN to the UE. When receiving this information, the UE may store it in the information about the user-controlled PLMNs.

### Case 3

In the automatic PLMN selection scheme, the order of priorities for PLMN selection is given as follows.

In an embodiment, the UE selects a PLMN in the following order.
1) RPLMN, EPLMN
2) User-controlled PLMN and access technology
3) Operator-controlled PLMN and access technology
4) PLMN reported as high-quality PLMN by AS layer

To assign a high priority to a network slice among PLMNs reported as high-quality PLMNs by the AS layer, network slice priority information, network slice group information, and so on may be used.

When agreed, a business provider (i.e., an operator) may use the network slice-related priority information, the network slice group information, and so on to assign a high priority for a network slice.
4-1) In an embodiment,
the network slice-related priority information for prioritization, the network slice information, and so on along with the PLMN list may be configured in the UE by being pre-configured and stored in the USIM.
4-2) In an embodiment,
the UE may use the network slice-related priority information, the network slice group information, and so on to assign a high priority for a network slice among high-quality PLMNs that meet a criterion of signal strength and signal quality. Alternatively, when agreed, the business provider (i.e., operator) may use the network slice-related priority information, the network slice group information, and so on to assign a high priority for a network slice.

### Case 4

In a manual PLMN selection scheme, the user may select one PLMN from a list of PLMNs provided by the AS layer of the UE.

When the UE successfully completes location registration, the selected PLMN becomes an RPLMN, that is, a registered PLMN. In other words, an RPLMN means a PLMN to which location registration is successfully completed. An EPLMN is a PLMN treated as equivalent to an RPLMN. In addition, a visited PLMN (VPLMN) refers to a PLMN that provides services to the UE in a roaming state.

In step 241, the UE 101 transmits an RRC connection request message to the 5G RAN 103-3. The RRC connection request message may be transmitted by the UE in the idle state to establish an RRC connection in response to a call attempt, a data transfer attempt, or paging.

In another embodiment, in step 241, the UE 101 transmits an RRC resume request message to the 5G RAN 103-3. The UE in the RRC inactive state may transmit the RRC resume request message to establish an RRC connection in response to a call attempt, a data transmission attempt, or paging.

In step 243, the UE 101 receives an RRC connection setup message as a response message from the 5G RAN 103-3. When the 5G RAN 103-3 accepts the connection request from the UE 101, the RRC connection setup message may be transmitted.

In another embodiment, in step 243, the UE 101 receives an RRC resume message as a response message from the 5G RAN 103-3. When the 5G RAN 103-3 has accepted the connection request from the UE 101, the RRC resume message may be transmitted.

Regarding steps 245-1 and 245-3, an RRC message is transmitted between the UE 101 and the 5G RAN 103 in step 245-1, and a NAS message is transmitted from the UE 101 to the AMF 111, that is, between the UE 101 and the AMF 111 based on the RRC message in step 245-3.

In step 245-1, the UE 101 transmits an RRC connection setup complete message to the 5G RAN 103-3 and transitions to an RRC connected mode.

In another embodiment, referring to step 245-1, the UE 101 transmits an RRC resume complete message to the 5G RAN 103-3 and transitions to the RRC connected mode.

A registration request message, which is a type of NAS message, may be piggybacked or concatenated to the RRC message (the RRC connection setup complete message or the RRC resume complete message) transmitted in step 245-1. In another embodiment, the RRC message transmitted in step 245-1 may include a registration request message, which is a type of NAS message.

In step 245-3, the UE 101 transmits the registration request message to the AMF 111. The registration request message may be transmitted to the 5G RAN 103-3 through an RRC message as described before with reference to step 245-1, and then transmitted to the AMF 111 by the 5G RAN 103-3.

In step 253, the AMF 111 transmits a registration accept message to the UE 101 through the 5G RAN 103-3. The registration accept message may include information about network slices related to the UE 101. The information about the network slices may include information about network slice groups available to the UE 101, information g-info about a list of the groups, information about the priorities of the network slices, or information p-list about a list of the priorities of the network slices.

The UE 101 may store the information about the network slices received from the network.

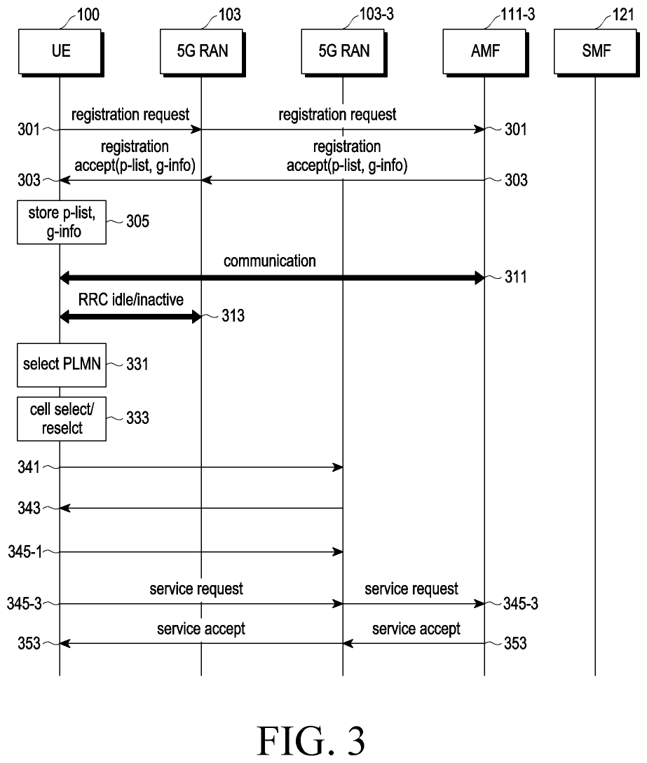

FIG. 3 is a flowchart illustrating a procedure in which a UE selects a network to be accessed according to a service to be accessed and a UE state according to an embodiment of the disclosure.

A description of steps 301 to 343 of FIG. 3 is substantially the same as the description of steps 201 to 243 of FIG. 2.

Regarding steps 345-1 and 345-3, an RRC message is transmitted between the UE 101 and the 5G RAN 103 in step 345-1, and a NAS message is transmitted from the UE 101 to the AMF 111, that is, between the UE 101 and the AMF 111 based on the RRC message in step 345-3.

In step 345-1, the UE 103-3 transmits an RRC connection setup complete message to the 5G RAN 103-3 and transitions to the RRC connection mode.

In an embodiment, in step 345-1, the UE 101 transmits a RRC resume complete message to the 5G RAN 103-3 and transitions to the RRC connection mode.

A service request message, which is a type of NAS message, may be piggybacked or concatenated to the RRC message (the RRC connection setup complete message or the RRC resume complete message) transmitted in step 345-1. In another embodiment, the RRC message transmitted in step 345-1 may include a service request message, which is a type of NAS message.

In step 345-3, the UE 101 transmits a service request message to the AMF 111. The service request message may be transmitted to the 5G RAN 103-3 through an RRC message as described above with reference to step 345-1, and then transmitted to the AMF 111 by the 5G RAN 103-3.

In step 353, the AMF 111 transmits a service accept message to the UE 101 through the 5G RAN 103-3. The service accept message may include information about network slices related to the UE 101. The information about the network slices may include information about network slice groups available to the UE 101, information g-info about a list of the groups, information about the priorities of the network slices, or information p-list about a list of the priorities of the network slices.

The UE 101 may store the information about the network slices received from the network.

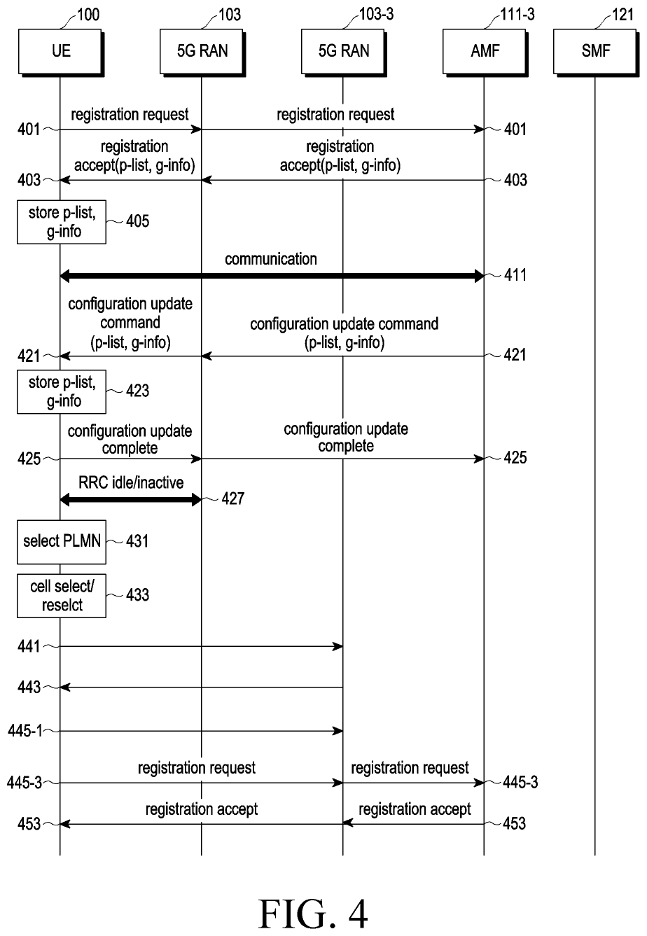

FIG. 4 is a flowchart illustrating a procedure in which a UE selects a network to be accessed according to a service to be accessed and a UE state according to an embodiment of the disclosure.

A description of steps 401 to 405 of FIG. 4 is substantially the same as the description of steps 201 to 205 of FIG. 2.

In step 411, the UE 101 communicates with a network.

In step 421, the AMF 111 transmits a configuration update command message to the UE 101 through the 5G RAN 103. The configuration update command message includes information about network slices related to the UE. The information about the network slices may include information about network slice groups available to the UE 101, information g-info about a group list, information about the priorities of the network slices, or information p-list about a list of the priorities of the network slices.

In step 423, the UE 101 may store the information about the network slices received from the network.

The UE 101 may update existing information that the UE 101 has, using the information about the network slices received from the network.

According to another embodiment, the UE 101 may store the received information about the network slices by add it to information about network slices that it already has.

In step 425, the UE 101 may notify the network or the AMF 111 that it has successfully received the information transmitted to the UE 101 by the AMF 111 and has stored, updated, or added the received information by transmitting a configuration update complete message to the AMF 111 through the 5G RAN 103.

In step 427, the UE 101 may be in the RRC idle or RRC inactive state with respect to the 5G RAN 103.

A description of steps 431 to 453 is substantially the same as the description of steps 231 to 253 of FIG. 2.

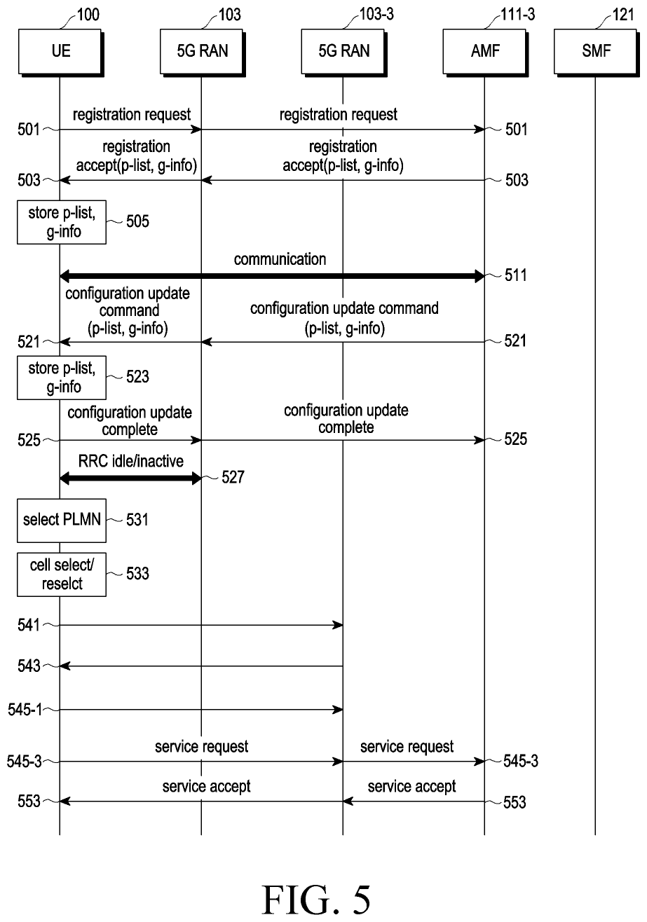

FIG. 5 is a flowchart illustrating a procedure in which a UE selects a network to be accessed according to a service to be accessed and a UE state according to an embodiment of the disclosure.

A description of steps 501 to 511 of FIG. 5 is substantially the same as the description of steps 201 to 211 of FIG. 2.

A description of steps 521 to 543 of FIG. 5 is substantially the same as the description of steps 421 to 443 of FIG. 4.

A description of steps 545-1 to 553 of FIG. 5 is substantially the same as the description of steps 345-1 to 353 of FIG. 3.

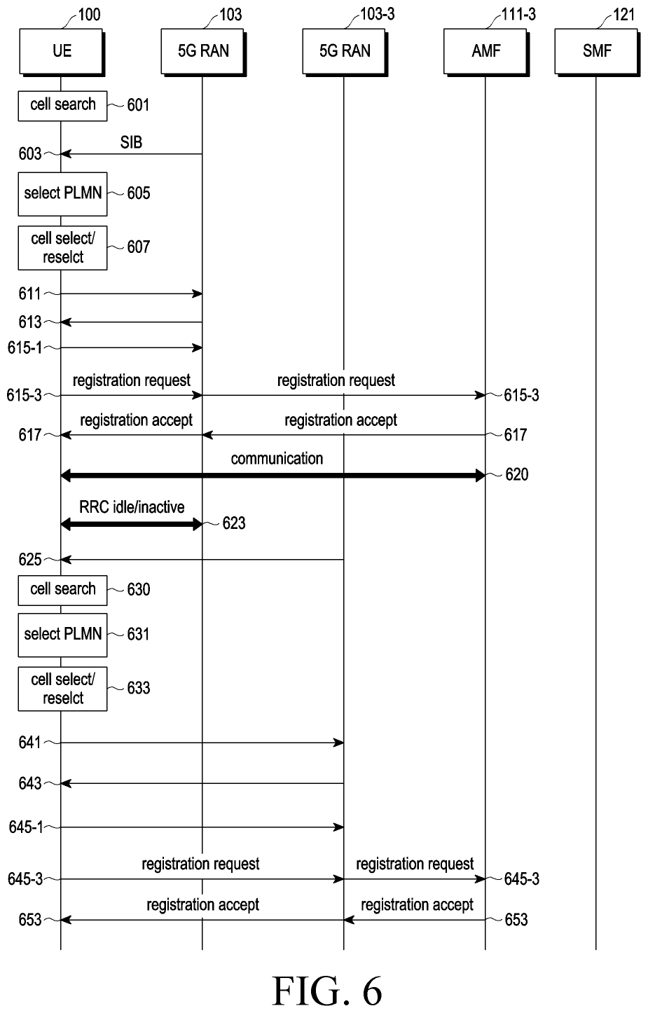

FIG. 6 is a flowchart illustrating a procedure in which a UE selects a network to be accessed according to a service to be accessed and a UE state according to an embodiment of the disclosure.

In step 601, the UE 101 performs a cell search.

In step 603, the UE 101 receives a system information block (SIB) from the 5G RAN 103. The UE 101 receives the SIB through the AS layer. The SIB may include information about network slices. The information about the network slices may include information about the groups of the network slices and information about the priorities of the network slices.

The information about the network slices received through the AS layer may be transmitted from the AMF 111 to the 5G RAN 103, and then broadcast from the 5G RAN 103 to UEs through an SIB or the like. In some embodiments, the 5G RAN 103 may transmit the information about the network slices to the AS layer of the UE 101 through a dedicated message, such as an RRC message (e.g., an RRC release message). Apart from the RRC release message, the information about the network slices may be transmitted through other RRC messages depending on a situation and a usage, and a newly defined RRC message may be used to transmit the information about the network slices.

The UE 101 may store the information about the network slices received through the AS layer in the USIM or the non-volatile memory.

In an embodiment, the information about the network slices may be provided for serving frequencies, and according to some embodiments, also for neighboring frequencies.

In step 605, the UE 101 may select a PLMN. In step 607, the UE may perform cell selection/cell reselection.

A detailed description of steps 605 and 607 is substantially the same as the description of steps 231 and 233 of FIG. 2.

In step 611, the UE 101 transmits an RRC connection request message to the 5G RAN 103-3. The UE in the idle state may transmit the RRC connection request message to establish an RRC connection in response to a call attempt, a data transfer attempt, or paging.

In step 613, the UE 101 receives an RRC connection setup message as a response message from the 5G RAN 103-3. When the 5G RAN 103-3 accepts the connection request from the UE 101, the RRC connection setup message may be transmitted.

Regarding steps 615-1 and 615-3, an RRC message is transmitted between the UE 101 and the 5G RAN 103 in step 615-1, and a NAS message is transmitted from the UE 101 to the AMF 111, that is, between the UE 101 and the AMF 111 based on the RRC message in step 615-3.

In step 615-1, the UE 101 transmits an RRC connection setup complete message to the 5G RAN 103-3 and transitions to the RRC connected mode.

A registration request message, which is a type of NAS message, may be piggybacked or concatenated to the RRC message (the RRC connection setup complete message) transmitted in step 615-1. In another embodiment, the RRC message transmitted in step 615-1 may include the registration request message, which is a type of NAS message.

A description of steps 615-3 to 623 is substantially the same as the description of steps 201 to 213 of FIG. 2.

In step 623, the UE 101 and the 5G RAN 103 may be in the RRC idle state or in the RRC inactive state.

In step 625, the 5G RAN 103-3 transmits a paging message to the UE 101.

In step 630, the UE performs a cell search.

A description of steps 631 to 653 is substantially the same as the description of steps 231 to 253 of FIG. 2.

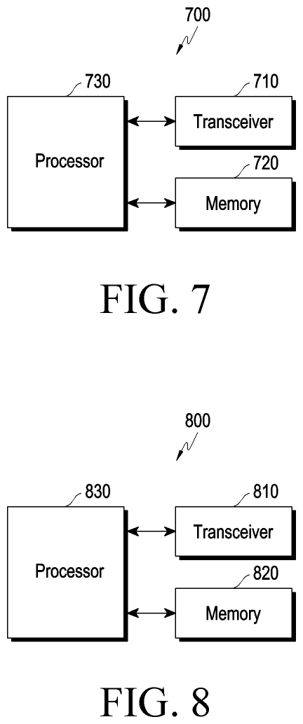

FIG. 7 is a block diagram illustrating the configuration of a UE according to an embodiment of the disclosure.

As illustrated in FIG. 7, a UE 700 of the disclosure may include a transceiver 710, memory 720, and a processor 730. The processor 730, the transceiver 710, and the memory 720 of the UE may operate according to the afore-described communication methods of the UE (i.e., terminal). However, the components of the UE are not limited to the above example. For example, the UE may include more or fewer components than the afore-mentioned components. Further, the processor 730, the transceiver 710, and the memory 720 may be implemented on a single chip.

The transceiver 710, which collectively refers to a receiver of the UE and a transmitter of the UE, may transmit and receive signals to and from a BS or a network entity. The signals to and from the BS may include control information and data. To this end, the transceiver 710 may include an RF transmitter that up-converts and amplifies the frequency of a transmission signal, and an RF receiver that low-noise amplifies and down-converts the frequency of a received signal. However, this is only an embodiment of the transceiver 710, and the components of the transceiver 710 are not limited to the RF transmitter and the RF receiver.

Further, the transceiver 710 may include a wired/wireless transceiver, and include various components to transmit and receive signals.

Further, the transceiver 710 may receive a signal through a wireless channel, output the received signal to the processor 730, and transmit a signal output from the processor 730 through a wireless channel.

Further, the transceiver 710 may receive a communication signal, output it to the processor, and transmit a signal output from the processor to a network entity over a wired or wireless network.

The memory 720 may store a program and data required for operation of the UE. In addition, the memory 720 may store control information or data included in a signal obtained by the UE. The memory 720 may include a storage medium, such as a ROM, a RAM, a hard disk, a CD-ROM, or a DVD, or a combination of these storage media. The memory 720 may include instructions to operate the UE. The instructions may be executed by the processor 730 to cause the UE to perform operations of the UE according to the embodiments of the disclosure described above.

The processor 730 may control a series of processes to enable the UE to operate according to the embodiments of the disclosure described above. The processor 730 may include at least one processor. For example, the processor 730 may include a communication processor (CP) that performs control for communication and an application processor (AP) that controls a higher layer, such as an application program. The processor 730 may also be referred to as a controller.

FIG. 8 is a block diagram illustrating the configuration of a network entity according to an embodiment of the disclosure.

As illustrated in FIG. 8, a network entity 800 of the disclosure may include a transceiver 810, memory 820, and a processor 830. The processor 830, the transceiver 810, and the memory 820 of the network entity may operate according to the afore-described communication methods of the network entity. However, the components of network entity are not limited to the above example. For example, the network entity may include more or fewer components than the afore-mentioned components. Further, the processor 830, the transceiver 810, and the memory 820 may be implemented on a single chip. The network entity may include an NF such as an AMF, an SMF, a PCF, an NEF, a UDM, or a UPF, which has been described above. Further, the network entity may also include a BS.

The transceiver 810, which collectively refers to a receiver of the network entity and a transmitter of the network entity, may transmit and receive signals to and from a UE or another network entity. The transmitted/received signals may include control information and data. To this end, the transceiver 810 may include an RF transmitter that up-converts and amplifies the frequency of a transmission signal, and an RF receiver that low-noise amplifies and down-converts the frequency of a received signal. However, this is only an embodiment of the transceiver 810, and the components of the transceiver 810 are not limited to the RF transmitter and the RF receiver.

Further, the transceiver 810 may receive a signal through a communication channel (e.g., a wireless channel), output the received signal to the processor 830, and transmit a signal output from the processor 830 through a wireless channel.

Further, the transceiver 810 may receive a communication signal, output it to the processor, and transmit a signal output from the processor to a UE or a network entity over a wired or wireless network.

The memory 820 may store a program and data required for operation of the network entity. In addition, the memory 820 may store control information or data included in a signal obtained by the network entity. The memory 820 may include a storage medium, such as a ROM, a RAM, a hard disk, a CD-ROM, or a DVD, or a combination of these storage media. The memory 820 may include instructions to operate the network entity. The instructions may be executed by the processor 830 to cause the UE to perform operations of the UE according to the embodiments of the disclosure described above.

The processor 830 may control a series of processes to enable the network entity to operate according to the embodiments of the disclosure described above. The processor 830 may include at least one processor. The processor 830 may also be referred to as a controller.

Methods according to the claims of the disclosure or the embodiments described herein may be implemented in the form of hardware, software, or a combination of hardware and software.

In the case of implementation in software, a computer-readable storage medium storing one or more programs (software modules) may be provided. The one or more programs stored on the computer-readable storage medium are configured to be executed by at least one processor in an electronic device. The one or more programs include instructions that cause the electronic device to perform the methods according to the claims of the disclosure or the embodiments described herein.

These programs (software modules or software) may be stored in RAM, non-volatile memory including flash memory, electrically erasable programmable read only memory (EEPROM), a magnetic disc storage device, compact disc-ROM (CD-ROM), a digital versatile disk (DVD), other forms of optical storage, a magnetic cassette, or a combination of some or all of them. Further, each of the constituent memories may be plural.

Further, the program may be stored in an attachable storage device that is accessible through a communication network such as the Internet, an intranet, a local area network (LAN), a wide area network (WAN), or a storage area network (SAN), or a combination of them. The storage device may be accessible to a device that performs an embodiment of the disclosure through an external port. Additionally, a separate storage device on a communication network may access the device performing the embodiments of the disclosure.

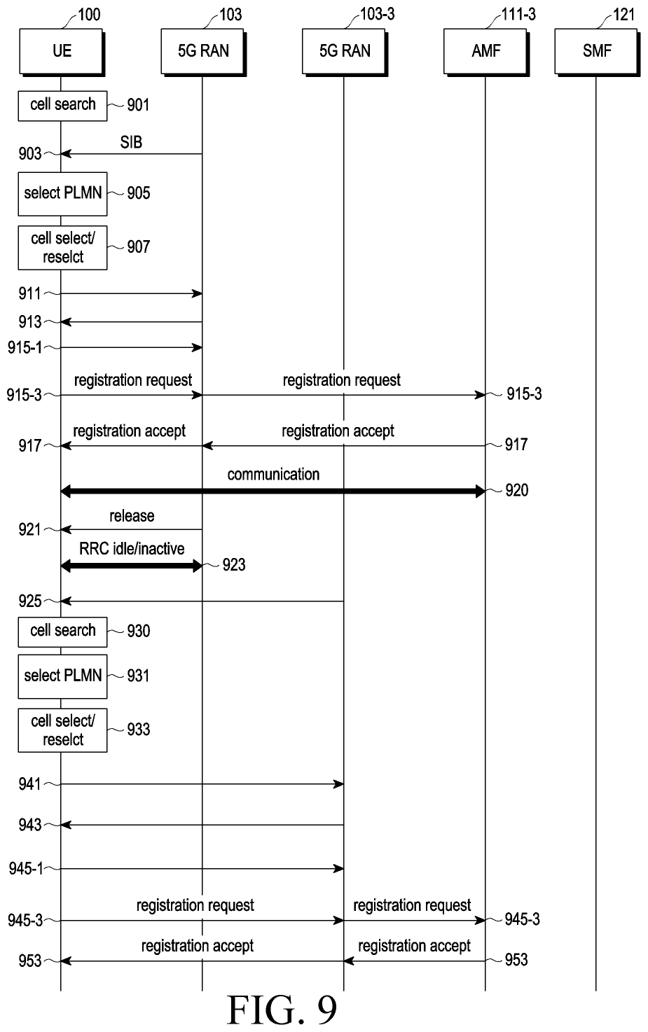

FIG. 9 is a flowchart illustrating a procedure in which a UE selects a network to be accessed according to a network to be accessed and a UE state according to an embodiment of the disclosure.

A description of steps 901 to 920 is substantially the same as the description of steps 601 to 620 of FIG. 6.

In step 921, the 5G RAN 103 may transmit an RRC release message to the UE 101. The RRC release message may include information about network slices. The information about the network slices may include information about groups of the network slices and information about the priorities of the network slices. That is, in the embodiment of FIG. 9, the information about the network slices may be transmitted to the UE 101 through an RRC release message, which is a dedicated signal. In some embodiments, the information about the network slices may be transmitted from the 5G RAN 103 to the UE 101 through an RRC control message other than the RRC release message.

A description of steps 923 to 953 is substantially the same as the description of steps 623 to 653 of FIG. 6.

In the above-described specific embodiments of the disclosure, the components included in the disclosure are expressed in a singular or plural form, depending on the specific embodiments which are presented. However, the singular or plural expression is chosen suitably for a situation presented for ease of description, and the disclosure is not limited to singular or plural components, and components expressed in a plural form may be included in a singular form, or components expressed as singular may be included as plural.

While specific embodiments have been described in the detailed description of the disclosure, it is apparent that various modifications can be made without departing from the scope of the disclosure. Therefore, the scope of the disclosure should not be limited to the embodiments described, but should be defined by the scope of the following claims and their equivalents.

1. A method for selecting a network by a terminal, the method comprising:
receiving information about a network slice from an access and mobility management function (AMF), wherein the information about the network slice includes at least one of information about a group of the network slice, information about priority of the network slice, and information about priority of the group of the network slice; and
performing cell selection or cell reselection based on the received information about the network slice.

2. The method of claim 1, wherein performing the cell selection or the cell reselection comprises transmitting the information about the network slice from a non-access stratum (NAS) layer of the terminal to an access stratum (AS) layer of the terminal.

3. The method of claim 1, further comprising selecting a public land mobile network (PLMN) based on the received information about the network slice.

4. The method of claim 1,
wherein the information about the group of the network slice includes information indicating at least one group of network slice available to the terminal,
wherein network slices are grouped according to at least one of a slice/service type (SST) and a slice differentiator (SD) corresponding to each of the network slices,
wherein the information about the priority of the network slice includes information indicating a priority of each of the at least one group and information indicating a priority of an individual network slice, and
wherein the information about the priority of the group of the network slice includes information indicating a priority of each of the at least one group.

5. The method of claim 1,
wherein the information about the network slice is received through a NAS message, and
wherein the NAS message is transmitted from the AMF to a base station, and the NAS message is transmitted to the terminal through bypassing by the base station.

6. The method of claim 5, wherein the NAS message is one of a registration accept message, a service accept message, and a configuration update command message.

7. The method of claim 1, wherein receiving the information about the network slice comprises receiving a system information block (SIB) including the information about the network slice, broadcast by a base station, or receiving a radio resource control (RRC) message including the information about the network slice from the base station.

8. A method for supporting network selection of a terminal by an access and mobility management function (AMF), the method comprising:
generating information about a network slice, wherein the information about the network slice includes at least one of information about a group of the network slice, information about priority of the network slice, and information about priority of the group of the network slice; and
transmitting the generated information about the network slice to the terminal.

9. The method of claim 8,
wherein the information about the groups of the network slice includes information indicating at least one group of network slice available to the terminal,
wherein network slices are grouped according to a service type corresponding to each of the network slices, and
wherein the information about the priority of the network slice includes information indicating a priority of each of the at least one group and information indicating a priority of an individual network slice.

10. The method of claim 8,
wherein transmitting the generated information about the network slice to the terminal comprises transmitting a NAS message including the information about the network slice to the terminal, and
wherein the NAS message is transmitted to the terminal through bypassing by a base station.

11. The method of claim 10, wherein the NAS message is one of a registration accept message, a service accept message, and a configuration update command message.

12. The method of claim 8,
wherein transmitting the generated information about the network slice to the terminal comprises transmitting the information about the network slice to a BS, and
wherein the information about the network slice is transmitted to the terminal through a system information block (SIB) including the information about the network slice, broadcast by the base station.

13. The method of claim 8,
wherein transmitting the generated information about the network slice to the terminal comprises transmitting the information about the network slice to a base station, and
wherein the information about the network slices is transmitted to the terminal by transmitting a radio resource control (RRC) message including the information about the network slice to the terminal by the base station.

14. A terminal for selecting a network, comprising:
a transceiver; and
a processor coupled to the transceiver,
wherein the processor is configured to:
receive information about a network slice from an access and mobility management function (AMF), wherein the information about the network slice includes at least one of information about a group of the network slice. information about priority of the network slice, and information about priority of the group of the network slice; and
perform cell selection or cell reselection based on the received information about the network slice.

15. (canceled)

16. The terminal of claim 14, wherein performing the cell selection or the cell reselection comprises transmitting the information about the network slice from a non-access stratum (NAS) layer of the terminal to an access stratum (AS) layer of the terminal.

17. The terminal of claim 14, wherein the processor is further configured to select a public land mobile network (PLMN) based on the received information about the network slice.

18. The terminal of claim 14,
wherein the information about the group of the network slice includes information indicating at least one group of network slice available to the terminal,
wherein network slices are grouped according to at least one of a slice/service type (SST) and a slice differentiator (SD) corresponding to each of the network slices,
wherein the information about the priority of the network slice includes information indicating a priority of each of the at least one group and information indicating a priority of an individual network slice, and
wherein the information about the priority of the group of the network slice includes information indicating a priority of each of the at least one group.

19. The terminal of claim 14,
wherein the information about the network slice is received through a NAS message, and
wherein the NAS message is transmitted from the AMF to a base station, and the NAS message is transmitted to the terminal through bypassing by the base station.

20. The terminal of claim 19, wherein the NAS message is one of a registration accept message, a service accept message, and a configuration update command message.

21. The terminal of claim 14, wherein the processor is further configured to receive a system information block (SIB) including the information about the network slice, broadcast by a base station, or receiving a radio resource control (RRC) message including the information about the network slice from the base station.
